(19) United States
(12) Patent Application Publication
(10) Pub. No.: US 2013/0199155 A1
(43) Pub. Date: Aug. 8, 2013

(54) Rocket Propulsion Systems, and Related Methods

(71) Applicant: Jordin Kare, Seattle, WA (US)

(72) Inventor: Jordin Kare, Seattle, WA (US)

(21) Appl. No.: 13/733,100

(22) Filed: Jan. 3, 2013

Related U.S. Application Data
(60) Provisional application No. 61/582,480, filed on Jan. 2, 2012.

(51) Int. Cl. F02K 9/00

(52) U.S. Cl. CPC F02K 9/00
USPC 60/211; 60/200.1

(57) ABSTRACT

In an aspect of the invention, a system for rocket propulsion includes a heater operable to generate thermal energy from energy supplied from a non-chemical energy source, and to supply the thermal energy to a non-cryogenic fuel to thermally decompose the fuel into components that include at least a first component and a second component. The rocket propulsion system also includes a combustion chamber and a nozzle. The combustion chamber is operable to receive an oxidizer and at least a portion of the thermally decomposed fuel, and allow the two to combust. The nozzle generates thrust by directing the products of the combustion out of the system.

### CROSS REFERENCE TO RELATED APPLICATION AND CLAIM OF PRIORITY

This application claims priority from commonly owned U.S. Provisional Patent Application 61/582,480 filed 2 Jan. 2012, and titled “Thermal Heater-Enhanced Rocket Propulsion System”, which is presently pending and incorporated by reference.

### BACKGROUND

Rockets are propelled by hot gas expelled through a nozzle.

For rocket applications requiring thrust-to-propulsion-system-weight ratios of order 1 or higher, including space launch vehicles, the only technology currently in use is the chemical rocket. As shown in FIG. 1, a chemical rocket comprises a supply of propellants: fuel 100 and oxidizer 110. The fuel and oxidizer, typically in liquid form¹, are injected into a combustion chamber 120 where the two mix and combust; the hot combustion products are exhausted through a nozzle 130, producing an exhaust 140 of high-velocity gas. ¹ Solid launch vehicles combine fuel and oxidizer in a solid matrix that reacts when ignited to generate thrust, essentially combining the functions of propellant tanks and combustion chamber. Electric propulsion (or ion propulsion), while extremely efficient and useful in providing propulsion either once in orbit or for interplanetary travel, produces insufficient thrust to be practical for use in launch vehicles.

Rocket propulsion systems are characterized by their specific impulse, Iₛₚ, defined as the impulse (thrust×time) produced per unit mass of propellant exhausted. For historical reasons, a factor of g (acceleration of gravity, 9.8 m/s²) is incorporated in the definition, so Iₛₚ has units of seconds. Iₛₚ in a vacuum is proportional to the mass-averaged exhaust velocity of the exhaust gas:

gIₛₚ=(vₑₓₕ)=−thrust/\dot{m}ₚᵣₒₚ

where \dot{m}ₚᵣₒₚ is the rate of change of propellant mass (a negative value, as propellant is consumed).

In chemical rockets, the specific impulse is determined primarily by the propellants used; each combination of fuel and oxidizer releases a particular amount of chemical energy dE per unit mass dmₚᵣₒₚ when burned; dE/dmₚᵣₒₚ is the specific energy, or the energy of combustion, of the propellants. Ideally, all of this energy can be converted to kinetic energy of the exhaust gas by the nozzle:

½vₑₓₕ²=dE/dmₚᵣₒₚ

In reality, there are various losses which reduce the actual exhaust velocity and Iₛₚ, and computer models are used to calculate Iₛₚ for particular propellants under specific conditions, but in general, higher specific energy propellants yield higher Iₛₚs.

Liquid-fueled rockets of the type illustrated in FIG. 1 commonly use a combination of either a room temperature fuel such as kerosene or similar hydrocarbons combined with liquid oxygen (LOX) (used for the Saturn V 1st stage and the SpaceX Falcon series) or liquid hydrogen (LH₂) with LOX (such as the space shuttle main engine). LOX-hydrogen provides the highest specific energy, and thus the highest Iₛₚ, of any practical propellant combination. Due to some of the loss factors noted above, the highest practical Iₛₚ is achieved with a “fuel rich” combination, typically 1 kg hydrogen to 5-6 kg oxygen, even though the maximum specific energy is achieved at the stoichiometric mass ratio of 1:8.

The only major class of high-thrust alternatives to chemical rockets are thermal rockets, which transfer heat from a non-chemical source to a propellant, as illustrated in FIG. 2. Thermal rocket propulsion systems consist of a supply of propellant 200 (formally not a fuel, as it is never burned). The propellant 200 flows through a heater 220 which transfers heat energy to the propellant, raising its temperature. The hot propellant is then expanded through a nozzle 230 to generate thrust; there is no combustion chamber, as there is no combustion. The energy which operates the heater can come from any type of non-chemical source 210, including an onboard nuclear reactor, the sun (via a solar collector), or a remote laser or microwave transmitter which sends a focused beam of energy to the rocket vehicle.

In thermal rockets, Iₛₚ is determined primarily by the temperature of the propellant, and its molecular weight; since each molecule (in thermal equilibrium) has on average kinetic energy (γ/γ-1) kT, lighter molecules have more energy per unit mass. (The specific heat ratio γ tends to vary slowly with molecular mass, except for the initial jump from monatomic gases like helium, γ=5/3, to diatomic gases with γ=7/5.) For any given temperature, liquid hydrogen, molecular weight 2, provides by far the highest Iₛₚ of any propellant.

However, liquid hydrogen has a very low density (0.07 g/cm³). The density ρ of propellants determines the volume, and therefore the mass, of the tanks required to hold them; an approximate rule of thumb is that launch vehicle tanks have a tank mass mₜₐₙₖ≈0.01 g/cm³×m/ρ, where m is the mass of the tank's contents. By this rule a hydrogen tank would have a mass of 14% of the hydrogen it holds. Pumps, plumbing, nozzles and other engine components also tend to be lighter (for a given mass flow rate or thrust) for higher density propellants. There is thus a large mass benefit to avoiding the use of hydrogen as a fuel for chemical rockets or a propellant for thermal rockets.

The relative importance of density and specific impulse depends on the particular rocket mission, but the product of the density of the fuel (ρ) times the Iₛₚ of the fuel, (ρ×Iₛₚ), is a useful metric for single-stage-to-orbit launch vehicles, a long-standing goal of rocket technology. Iₛₚ, density, and density×Iₛₚ, for some propellants are tabulated in Table 1.

Hydrogen is also cryogenic, with a boiling point (at 1 atmosphere of pressure) of 27 K. Hydrogen tanks thus generally require insulation (205 in FIG. 2), as well as special materials and designs for pumps, valves, and other components exposed to liquid hydrogen. Even in very large chemical rockets such as the Space Shuttle and Ariane, insulation on the hydrogen tank represents a substantial mass penalty; smaller rockets, particularly thermal rockets using only hydrogen propellant, suffer a proportionally larger penalty due to their greater surface-to-volume ratio. Although the use of liquid hydrogen in rockets is now established technology, handling it is a significant contributor to rocket costs.

There is therefore a need for a rocket propellant combination and rocket propulsion system which provides a superior combination of specific impulse and density to existing combinations, while not requiring the specialized tanks and other hardware necessary to use liquid hydrogen.

### SUMMARY

In an aspect of the invention, a system for rocket propulsion includes a heater operable to generate thermal energy from energy supplied from a non-chemical energy source, and to supply the thermal energy to a non-cryogenic fuel to thermally decompose the fuel into components that include at least a first component and a second component. The rocket propulsion system also includes a combustion chamber and a nozzle. The combustion chamber is operable to receive an oxidizer and at least a portion of the thermally decomposed fuel, and allow the two to combust. The nozzle generates thrust by directing the products of the combustion out of the system.

### BRIEF DESCRIPTION OF THE FIGURES

FIG. 1 is a schematic view of a conventional, chemical rocket-propulsion system.

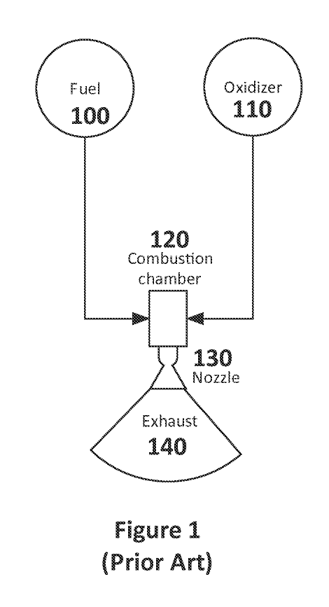

FIG. 2 is a schematic view of a conventional, thermal rocket-propulsion system.

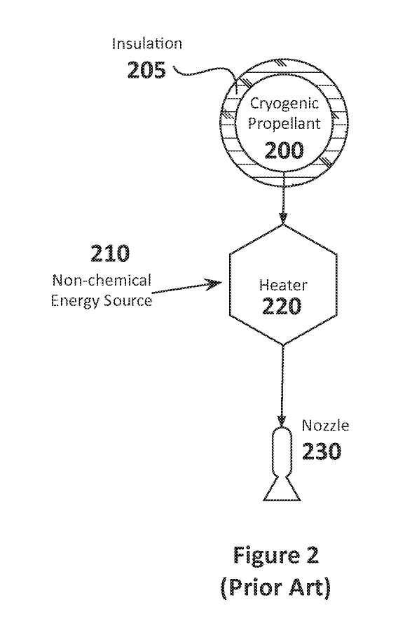

FIG. 3 is a schematic view of a rocket-propulsion system, according to an embodiment of the invention.

FIG. 4 is a schematic view of a rocket-propulsion system, according to another embodiment of the invention.

FIG. 5 is a schematic view of a rocket-propulsion system, according to yet another embodiment of the invention.

FIG. 6 is a schematic view of a rocket-propulsion system, according to another embodiment of the invention.

FIG. 7 is a schematic view of a rocket-propulsion system, according to yet another embodiment of the invention.

### DETAILED DESCRIPTION

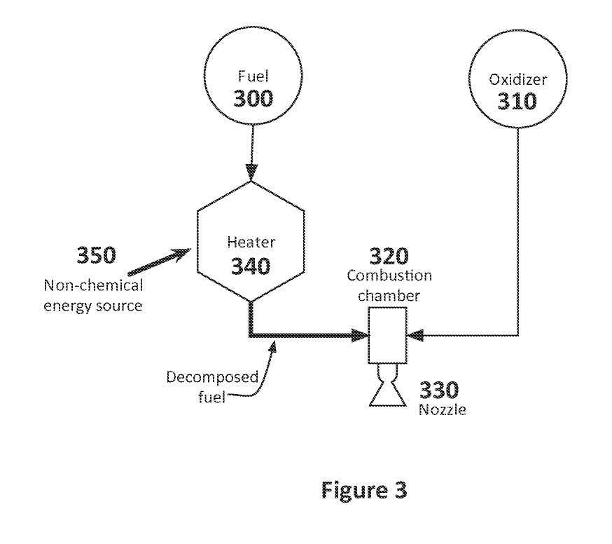

FIG. 3 is a schematic view of a rocket-propulsion system, according to an embodiment of the invention. The system includes a supply of fuel 300 (here ammonia —NH₃), an oxidizer 310, and a thermal heater 340 which heats the fuel 300 to a high temperature and causes a substantial portion of the fuel to thermally decompose into at least a first component and a second component prior to combustion with the oxidizer 310. To generate the thermal energy needed to thermally decompose the fuel 300, the heater 340 receives energy from a non-chemical source 350. In the case of ammonia, the fuel thermally decomposes primarily into molecular hydrogen (H₂) and nitrogen (N₂) according to the chemical formula:

2NH₃→N₂+3H₂

The decomposed fuel is then fed into a combustion chamber 320 configured to accommodate injection of the hot, decomposed fuel, where at least the hydrogen reacts with the oxidizer. The products of the reaction are then exhausted through a rocket nozzle 330 to produce thrust.

Note that, depending on the temperature and pressure of the decomposed fuel, many chemical species may be present, including small amounts of un-decomposed fuel. Also, some hydrogen molecules will dissociate into free hydrogen but at practical temperatures and pressures for high-thrust rockets only a small percentage of H₂ molecules will dissociate.

By using a heater to thermally decompose a substantial portion of the NH₃, the specific energy of the oxidizer/fuel combination LOX/NH₃ can be raised significantly. The increase in specific energy using NH₃ propellant is substantially greater than for most other propellants because NH₃ has a large heat of vaporization (−1.3 MJ/kg) and a substantial heat of formation (2.7 MJ/kg). Both of these must be provided by the chemical energy of the reaction in an all-chemical rocket, but can readily be provided by a heater without exceeding the practical temperature limits of the heater.

Referring to Table 1, it is clear that LOX/decomposed NH₃ has an exceptional combination of characteristics. It has a higher Iₛₚ than any propellant combination except LOX/H₂, with a much higher density than LOX/H₂ (and without the cryogenic requirements of liquid hydrogen). It has a higher Iₛₚ than the closest-density competing combination, LOX/methane (CH₄) by some 18%, and a much higher Iₛₚ than the denser chemical-rocket combinations. Notably, it also has a higher Iₛₚ and density than a pure thermal rocket using ammonia propellant, even though the latter includes in the Iₛₚ calculation the decomposition of the ammonia in the heater, so that the exhaust is assumed to be H₂ and N₂ with a mean molecular weight of 8.5.

The heater 340 may use any energy source 210 other than a chemical reaction. In some embodiments, the energy source may be a beam of energy from a remote source, such as a laser, an array of lasers, or microwave transmitter. Such remote sources can provide highly-concentrated power (many megawatts per square meter) to a heater, while adding no mass and minimal drag to a rocket vehicle.

In some embodiments, the energy source may be a nuclear reactor, sunlight focused onto a heater by a mirror or lens, or an electrical generator or electrical storage device (i.e., a battery) coupled to an electrically-powered heater, such as a resistive heater or electric arc heater.

The heater 340 may be a laminar- or turbulent-flow heater, with a single stage or multiple stages optimized for different temperature regimes or flow conditions. The energy source may be directly coupled to the heater (for example, a nuclear reactor in which propellant flows through the reactor core, or a laser beam which is absorbed by the propellant heater) or may be indirectly coupled, (e.g., a reactor which heats a circulating coolant fluid, which in turn transfers heat to the propellant heater, or a laser beam which is absorbed by photovoltaic cells, the photoelectric cells then producing electricity which in turn operates an electric heater). The heater may be comprised of any materials compatible with the fuel or its decomposition products, including, for example, steel, nickel or nickel alloys, refractory metals such as tungsten, molybdenum, rhenium, etc., ceramics such as silicon carbide, carbon, or composites of one or more of these.

While there is no specific limit, either upper or lower, on the temperature of the fuel as it leaves the heater, in general, the higher the temperature of the fuel when it enters the combustion chamber, the better the overall rocket performance will be. For solid heaters, temperatures between roughly 1,000 and 3,000 K, and particularly between 1000 and 2000 K are likely to be of most interest. 1,000 K is low enough to be compatible with a wide range of high-temperature metals and alloys. 2,000 K is roughly the working limit for widely-used refractory materials such as silicon carbide. 3,000 K is roughly the working limit for the highest-temperature refractory materials.

In some embodiments, the heater 340 may be a plasma sustained in the fuel flow by microwave or laser radiation. This configuration reduces the heating of the walls containing the fuel flow, and allows reaching fuel temperatures that are higher than those achievable with solid heaters.

The performance of the LOX/decomposed NH₃ combination is given in Table 2 for a range of heater temperatures up to 2,000 K, at two typical combustion chamber pressures: 200 psi (for a pressure-fed rocket) and 2,000 psi (for a pump-fed rocket) and at two typical vacuum expansion ratios.

Alternatives to ammonia include any fuel which has a substantial heat of vaporization and/or heat of formation, but which releases more energy when burned (in its decomposed form) with an oxidizer than is required to decompose it. For example, methane, hydrazine (N₂H₄), and various combinations of hydrazine and mono- or dimethyl hydrazine may be a fuel for the system. Methane has a boiling point, at 1 atmosphere of pressure, of −161 C (approximately 112 K). For the purposes of this application, we consider this as non-cryogenic, as liquid methane at or near its boiling point is not cold enough to condense atmospheric gases (oxygen and nitrogen). This is consistent with the definition used by the National Institute of Standards and Technology at Boulder, Colo., which considers the field of cryogenics as that involving temperatures below −180 C (93.15 K). Another common definition defines cryogenics as temperatures below −150 C (123.15 K). Methane can be stored as a liquid at this temperature under moderate pressure (2.4 atmospheres).

In other embodiments, a mixture or solution of other materials and ammonia may be a fuel, including particularly a combination of NH₃ and water (commonly also referred to as ammonia) in any proportions. Ammonia is an extremely powerful dessicant, and will thus generally contain at least a small amount of water. The presence of water in the fuel will have comparatively little effect on the overall performance of the propulsion system, since the water will be vaporized and heated to a substantial fraction of the exhaust temperature by the heater.

Other fuels are possible. For example, light metal hydrides, such as LiH, B₂H₆, and LiAlH₄ may also be potential fuels or fuel components.

While liquid oxygen is the most commonly used oxidizer for rocket propulsion, any oxidizer may be used, including oxides of nitrogen (N₂O, NO, NO₂, N₂O₄), nitric acid, fluorine, chlorine trifluoride, chlorine pentafluoride, and FLOX. High concentration hydrogen peroxide (HTP) may be used to provide a fuel/oxidizer combination that is storable at room temperature (the boiling point of ammonia is 0 C at ˜4 times atmospheric pressure, and 25 C at ˜10 times atmospheric pressure). The propulsion properties of H₂O₂/decomposed NH₃ are also given in Table 1 and Table 2.

The combustion chamber 320 and nozzle 330 may be of any suitable construction capable of withstanding the thermal and mechanical loads imposed on them. A wide range of materials, cooling methods, and means of fabrication are known in the art. The combustion chamber injector (not shown) may be of the gas-liquid or gas-gas type, as at least one of the propellants is already largely or entirely gaseous. In many cases no ignitor is required, as the heated fuel is well above the ignition temperature for any likely oxidizer, but an ignitor may be included.

The combustion cycle may be any rocket propulsion cycle, including but not limited to pressure fed, expander cycle using either fuel or oxidizer, or staged combustion. The combustion cycle may also use a variation of an expander cycle in which the pump is driven by gas tapped from the heater at any desired temperature.

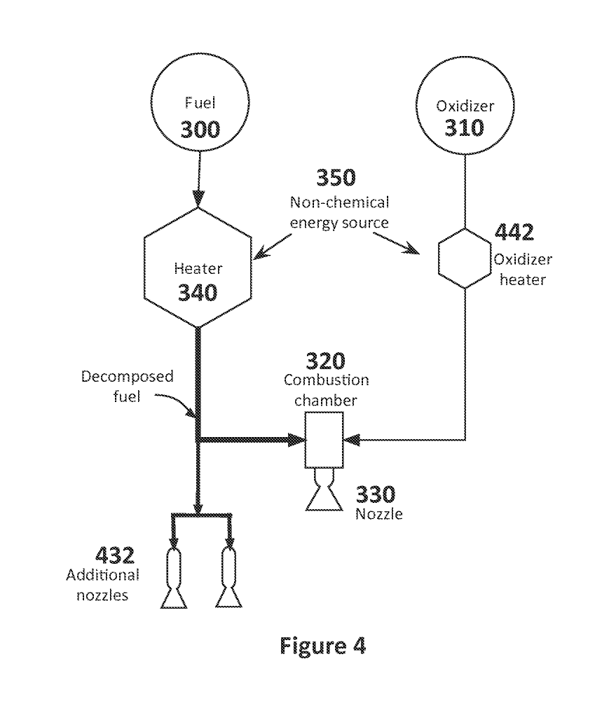

In some embodiments, the propulsion system may be configured to operate, for a duration, with a reduced amount of oxidizer, or entirely without an oxidizer, using only fuel heated by the heater 340. In particular, it may be desirable to carry a small amount of excess fuel so that the oxidizer tank can be reliably “run dry” to minimize the mass of unused (residual) propellant; the excess fuel can then provide thrust at a somewhat lower Iₛₚ until exhausted, without concern for maintaining a specific mixture ratio or combustion chamber pressure. Note that the various valves, actuators, and other system components which may be used to vary the fuel and/or oxidizer flow, and to configure the chamber and nozzle for different operating conditions are not shown in FIG. 3. In some embodiments of the rocket propulsion system, as shown in FIG. 4, a portion of the decomposed fuel may be used without an oxidizer in separate “hot gas” or “warm gas” thrusters, which include nozzles 432 (again, with control valves and other system components not shown). The nozzles 432 may be used to provide thrust for any desired purpose, such as attitude control, where the simplicity of monopropellant operation is more valuable than the higher Iₛₚ of bipropellant combustion.

Still referring to FIG. 4, in some embodiments, if sufficient power is available from the non-chemical energy source, a separate heater 442 may be used to raise the temperature of the oxidizer before it enters the combustion chamber 320. This can further increase the propulsion system Iₛₚ.

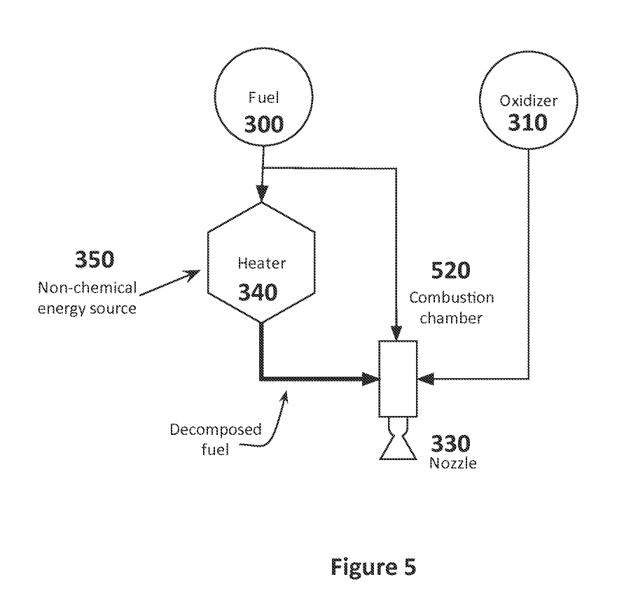

In some embodiments of the system, as shown in FIG. 5, the propulsion system may also produce thrust via conventional chemical combustion of fuel and oxidizer, without decomposition of the fuel by the heater. This may be done to provide thrust when non-chemical energy source 350 is not available, or is insufficient to supply the heater, for example because the rocket is out of range of a beamed-energy source, or to provide greater thrust (at lower specific impulse) than can be produced from the combustion of the decomposed fuel alone. In some embodiments, this conventional chemical propulsion may be provided by feeding the fuel 300 to the combustion chamber 520 as a liquid or comparatively cool, undecomposed gas. In some cases, liquid fuel may be fed directly to the combustion chamber from a fuel tank or pump, bypassing the heater 340. In other cases, it may flow through the heater 340 without being thermally decomposed, when the heater is unpowered or the fuel flow rate exceeds the ability of the heater to thermally decompose it.

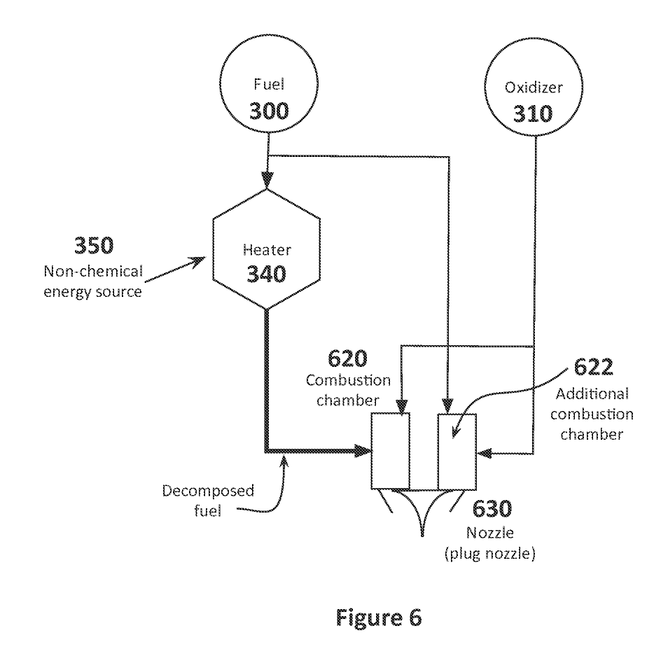

Referring now to FIG. 6, a separate combustion chamber 622 may be provided to combust undecomposed fuel and oxidizer, with the combustion products from this separate combustion chamber exhausted via a common nozzle 630 with the main combustion chamber. FIG. 6 shows, schematically, how this configuration might be used with a plug-type nozzle 630, which would typically have multiple small combustion chambers around a central expansion plug, alternating between high-Iₛₚ chambers 620 and lower-Iₛₚ chambers 622.

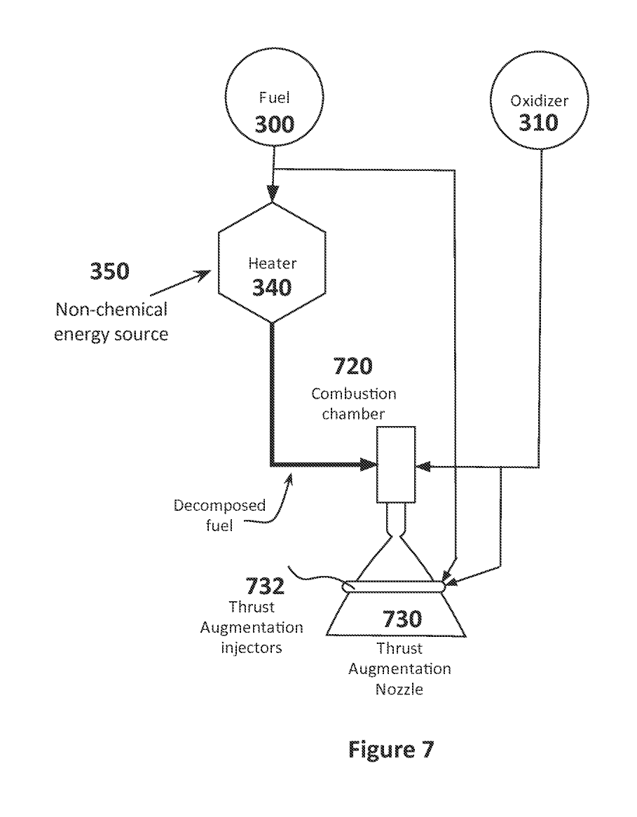

Referring to FIG. 7, un-decomposed fuel may be combusted with oxidizer to provide the thrust augmentation in a thrust-augmented nozzle 730, as described in U.S. Pat. No. 6,568,171 to Bulman titled “Rocket Vehicle Thrust Augmentation Within Divergent Section of Nozzle”, and incorporated herein by reference. This configuration is well suited to rockets or rocket stages launched from the ground, which require high thrust and low expansion ratios for initial ascent through the atmosphere, but can later operate at a higher specific impulse and a lower thrust. For high-Iₚ thrust in a vacuum, only the main combustion chamber 720 operates, burning thermally decomposed fuel with an oxidizer. For high-thrust operation, the main chamber 720 continues to operate, but un-decomposed fuel and oxidizer are injected into the bell of the nozzle 730 (or at comparable locations in plug nozzles or other types of nozzles) via the thrust augmentation injectors 732. The additional fuel and oxidizer burn within the nozzle 730, providing additional thrust and preventing overexpansion and instability of the exhaust flow from the main chamber 720.

TABLE 1
Comparison of Iₛₚ, density, and density × Iₛₚ for chemical, thermal, and
heater/combustion rockets (in vacuum, expansion ration 100).

| | Propellant | Density | Specific | Density |
|---|---|---|---|---|
| | Combination | (g/cm³) | Impulse (Iₛₚ) | × Iₛₚ |
| Chemical Rocket | LOX-H2 | 0.358 | 446 | 159.7 |
| | LOX-CH4 | 0.821 | 369 | 302.9 |
| | LOX-RP* | 1.031 | 358 | 369.1 |
| | HTP-RP | 1.312 | 327 | 429.0 |
| Thermal Rocket | H2 @ 1800K | 0.070 | 750 | 52.5 |
| | NH3 @ 1800K | 0.700 | 370 | 259.0 |
| Heater/ | LOX-NH3(decomp) | 0.890 | 420 | 373.8 |
| Combustion | HTP-NH3(decomp) | 1.120 | 368 | 412.2 |
| Rocket | | | | |

*RP is a standard kerosene-based fuel similar to jet fuel

TABLE 2
Specific Impulse data for NH₃ + LOX and NH₃ + HTP (H₂O₂).

| | LOX | | | | |
|---|---|---|---|---|---|
| | Augmented | | | | |
| | NH₃ | | | NH₃/H₂O₂ | |
| Expansion Ratio | 100 | 200 | Expansion Ratio | 100 | 200 |

| | | | | | |
|---|---|---|---|---|---|
| Fuel | Specific | Chamber | Fuel | Specific | Chamber |
| Temperature (K) | Impulse | Temperature (K) | Temperature (K) | Impulse | Temperature (K) |

Chamber Pressure 200 PSI

| | | | | | | | |
|---|---|---|---|---|---|---|---|
| 1,000 | 389.7 | 399.9 | 3,370.1 | 1,000 | 343.5 | 350.5 | 2,885.8 |
| 1,100 | 391.8 | 402.2 | 3,386.2 | 1,100 | 345.2 | 352.4 | 2,901.3 |
| 1,200 | 393.8 | 404.4 | 3,402.0 | 1,200 | 347.0 | 354.2 | 2,916.6 |
| 1,300 | 395.8 | 406.6 | 3,417.7 | 1,300 | 348.8 | 356.1 | 2,931.7 |
| 1,400 | 397.8 | 408.9 | 3,433.5 | 1,400 | 350.5 | 358.0 | 2,946.9 |
| 1,500 | 399.8 | 411.0 | 3,448.9 | 1,500 | 352.3 | 359.8 | 2,961.8 |
| 1,600 | 401.8 | 413.2 | 3,464.4 | 1,600 | 354.1 | 361.7 | 2,976.8 |
| 1,700 | 403.8 | 415.3 | 3,479.6 | 1,700 | 355.8 | 363.6 | 2,991.4 |
| 1,800 | 405.7 | 417.5 | 3,495.0 | 1,800 | 357.6 | 365.4 | 3,005.9 |
| 1,900 | 407.7 | 419.6 | 3,510.2 | 1,900 | 359.4 | 367.4 | 3,020.9 |

Chamber Pressure 2000 PSI

| | | | | | | | |
|---|---|---|---|---|---|---|---|
| 1,000 | 402.3 | 412.0 | 3,666.1 | 1,000 | 351.9 | 358.8 | 3,022.2 |
| 1,100 | 405.1 | 414.9 | 3,692.2 | 1,100 | 354.1 | 361.1 | 3,045.6 |
| 1,200 | 407.6 | 417.6 | 3,716.2 | 1,200 | 356.1 | 363.3 | 3,067.2 |
| 1,300 | 410.0 | 420.2 | 3,739.0 | 1,300 | 358.0 | 365.3 | 3,087.8 |
| 1,400 | 412.4 | 422.7 | 3,761.2 | 1,400 | 360.0 | 367.3 | 3,107.8 |
| 1,500 | 414.7 | 425.2 | 3,783.2 | 1,500 | 361.9 | 369.3 | 3,127.7 |
| 1,600 | 417.0 | 427.7 | 3,805.1 | 1,600 | 363.8 | 371.3 | 3,147.5 |
| 1,700 | 419.3 | 430.1 | 3,826.6 | 1,700 | 365.7 | 373.3 | 3,167.0 |
| 1,800 | 421.6 | 432.6 | 3,848.1 | 1,800 | 367.6 | 375.3 | 3,186.5 |
| 1,900 | 423.8 | 435.0 | 3,869.4 | 1,900 | 369.5 | 377.3 | 3,205.8 |

What is claimed is:

1. A system for rocket propulsion, the system comprising:
a heater operable to generate thermal energy from energy supplied from a non-chemical energy source, and to supply the thermal energy to a non-cryogenic fuel to thermally decompose the fuel into components that include at least a first component and a second component;
a combustion chamber operable to receive an oxidizer and at least a portion of the thermally decomposed fuel, and to allow the two to combust; and
a nozzle through which products of the combustion flow to generate thrust.

2. The system of claim 1 wherein the heater includes at least one of the following: a laminar-flow heater, a turbulent-flow heater, a microwave-sustained plasma heater, and a laser-sustained plasma heater.

3. The system of claim 1 wherein the heater is operable to heat the non-cryogenic fuel to more than 1,000 K.

4. The system of claim 1 wherein thermally decomposing the fuel includes vaporizing the fuel.

5. The system of claim 1 wherein the non-chemical energy source includes at least one of the following: a beam of electromagnetic radiation, a laser beam, microwave radiation, millimeter-wave radiation, and submillimeter-wave radiation.

6. The system of claim 1 wherein the non-chemical energy source includes at least one of the following: a nuclear reactor, an electric heater, and focused sunlight.

7. The system of claim 1 wherein the fuel includes ammonia (NH₃).

8. The system of claim 1 wherein the fuel includes at least one of the following: methane (CH₄), hydrazine, monomethylhydrazine, dimethylhydrazine, LiH, B₂H₆ and LiAlH₄.

9. The system of claim 1 wherein the first component of the thermally decomposed fuel includes hydrogen.

10. The system of claim 1 wherein the second component of the thermally decomposed fuel includes nitrogen.

11. The system of claim 1 wherein the oxidizer comprises at least one of the following: oxygen (O₂), ozone (O₃), hydrogen peroxide (H₂O₂), nitrous oxide (N₂O), nitric oxide (NO), nitrogen dioxide (NO₂), nitrogen tetroxide (N₂O₄), chlorine trifluoride (ClF₃), chlorine pentafluoride (ClF₅), and fluorine.

12. The system of claim 1 wherein energy supplied by the non-chemical energy source heats some or all of the oxidizer before combustion.

13. The system of claim 1 wherein the combustion chamber and nozzle are further operable to generate thrust from the decomposed fuel without combustion.

14. The system of claim 1 wherein the combustion chamber is configured to combust at least some un-decomposed fuel with the oxidizer.

15. The system of claim 1 further comprising another combustion chamber operable to combust un-decomposed fuel with the oxidizer.

16. The system of claim 15 wherein both combustion chambers share a common nozzle.

17. The system of claim 1 further comprising a thrust-augmented nozzle (TAN), operable to use decomposed fuel in the primary combustion chamber and to use un-decomposed fuel in the thrust-augmentation injectors.

18. A method for producing rocket thrust, the method comprising:
providing a heater energy from a non-chemical energy source;
supplying thermal energy via the heater to thermally decompose a non-cryogenic fuel into components that include at least a first component and a second component, before the fuel enters a combustion chamber;
mixing at least a portion of the decomposed fuel with an oxidizer to combust the two; and
directing the products of combustion through a nozzle to generate thrust.

19. The method of claim 18 wherein providing the heater energy from a non-chemical energy source includes providing the heater at least one of the following: a beam of electromagnetic radiation, a laser beam, microwave radiation, millimeter-wave radiation, and submillimeter-wave radiation.

20. The method of claim 18 wherein providing the heater energy from a non-chemical energy source includes providing the heater at least one of the following: electricity, focused sunlight, and nuclear energy.

21. The method of claim 18 further comprising producing additional rocket thrust by exhausting uncombusted, decomposed fuel through the nozzle.

22. The method of claim 18, further comprising producing additional rocket thrust by combusting un-decomposed fuel with the oxidizer and exhausting the combustion products through a nozzle.
